(19) United States
(12) Patent Application Publication
(10) Pub. No.: US 2014/0367377 A1
(43) Pub. Date: Dec. 18, 2014

(54) MICROWAVE HEATING APPARATUS AND HEATING METHOD

(71) Applicant: TOKYO ELECTRON LIMITED, Tokyo (JP)

(72) Inventors: Taichi MONDEN, Yamanashi (JP); Kouji SHIMOMURA, Yamanashi (JP); Seokhyoung HONG, Yamanashi (JP); Yoshihiro MIYAGAWA, Yamanashi (JP); Jun YAMASHITA, Yamanashi (JP); Taro IKEDA, Yamanashi (JP); Yuki MOTOMURA, Yamanashi (JP)

(73) Assignee: TOKYO ELECTRON LIMITED, Tokyo (JP)

(21) Appl. No.: 14/293,794

(22) Filed: Jun. 2, 2014

(30) Foreign Application Priority Data
Jun. 18, 2013 (JP) 2013-127100

(51) Int. Cl. H05B 6/74; H05B 6/80; H05B 6/64

(52) U.S. Cl. CPC H05B 6/74; H05B 6/6411; H05B 6/80
USPC 219/747

(57) ABSTRACT

A microwave heating apparatus includes a phase control unit configured to change a phase of a standing wave of microwave introduced into the process chamber by the microwave introduction unit. The phase control unit includes a recessed portion with respect to an inner surface of the bottom wall. The phase control unit is formed of a bottom portion and a fixing plate installed at a lower surface of the bottom portion from the outer side of the process chamber. The phase of the standing wave in the process chamber is changed by the incidence and reflection of the microwave in the recessed portion of the phase control unit surrounded by metallic wall.

### CROSS-REFERENCE TO RELATED APPLICATION

This application claims priority to Japanese Patent Application No. 2013-127100 filed on Jun. 18, 2013, the entire contents of which are incorporated herein by reference.

### FIELD OF THE INVENTION

The present invention relates to a microwave heating apparatus for performing a predetermined process by introducing a microwave into a process chamber and a heating method for heating an object to be processed by using the microwave heating apparatus.

### BACKGROUND OF THE INVENTION

As an LSI device or a memory device is miniaturized, a depth of a diffusion layer in a transistor manufacturing process is decreased. Conventionally, doping atoms implanted to the diffusion layer are activated by a high-speed heating process referred to as an RTA (Rapid Thermal Annealing) using a lamp heater. However, in the RTA process, since the diffusion of the doping atoms progresses, the depth of the diffusion layer exceeds a tolerable range, which makes difficult a miniaturized design. If the depth of the diffusion layer is incompletely controlled, the electrical characteristics of devices deteriorate due to occurrence of leakage current or the like.

Recently, an apparatus using microwaves is suggested as an apparatus for heating a semiconductor wafer. When doping atoms are activated by microwave heating, a microwave directly acts on the doping atoms. Therefore, excessive heating does not occur, and the diffusion of the diffusion layer can be suppressed.

As for the heating apparatus using microwaves, there is suggested in, e.g., Japanese Patent Application Publication No. H3-233888 (see, e.g., FIG. 1), a microwave radiation unit in which conductive protrusions are unevenly distributed on a surface of a conductive guide plate in order to uniformly heat an object to be processed.

The microwave has a long wavelength of several tens of millimeters and has a feature that standing waves can be easily formed in the process chamber. Accordingly, when the semiconductor wafer is heated by using a microwave, for example, electromagnetic field distribution becomes non-uniform in the surface of the semiconductor wafer, which makes the heating temperature non-uniform.

### SUMMARY OF THE INVENTION

In view of the above, the present invention provides a microwave heating apparatus and a heating method capable of uniformly and effectively heating an object to be processed.

In accordance with an aspect of the present invention, there is provided a microwave heating apparatus including: a process chamber configured to accommodate an object to be processed, the process chamber having a top wall, a bottom wall and a sidewall; a microwave introduction unit configured to generate a microwave for heating the object and introduce the microwave into the process chamber; a supporting unit configured to make contact with the object to support the object in the process chamber; and a phase control unit disposed below the object supported by the supporting unit and configured to change a phase of a standing wave of the microwave introduced into the process chamber by the microwave introduction unit.

In accordance with another aspect of the present invention, there is provided a method for heating an object by using a microwave heating apparatus including: a process chamber configured to accommodate an object to be processed, the process chamber having a top wall, a bottom wall and a sidewall; a microwave introduction unit configured to generate a microwave for heating the object and introduce the microwave into the process chamber; a supporting unit configured to make contact with the object to support the object in the process chamber; and a phase control unit disposed below the object supported by the supporting unit and configured to change a phase of a standing wave of the microwave introduced into the process chamber by the microwave introduction unit.

### BRIEF DESCRIPTION OF THE DRAWINGS

The objects and features of the present invention will become apparent from the following description of embodiments, given in conjunction with the accompanying drawings, in which:

FIG. 1 is a cross sectional view showing a schematic configuration of a microwave heating apparatus in accordance with a first embodiment of the present invention;

FIG. 2 is a partial enlarged cross sectional view showing a configuration around a phase control unit of the microwave heating apparatus in accordance with the first embodiment of the present invention;

FIG. 3 is a perspective view showing an entire structure of a fitting plate as an example of an auxiliary member;

FIG. 4 is a partial enlarged cross sectional view showing a configuration around a phase control unit to which the fitting plate shown in FIG. 3 is installed;

FIG. 5 is a partial enlarged cross sectional view showing another configuration around a phase control unit to which the fitting plate shown in FIG. 3 is installed;

FIG. 6 is a perspective view showing an entire structure of a fitting plate as another example of the auxiliary member;

FIG. 7 is a partial enlarged cross sectional view showing a configuration around a phase control unit to which the fitting plate shown in FIG. 6 is installed;

FIG. 8 is a partial enlarged cross sectional view showing another configuration around a phase control unit to which the fitting plate shown in FIG. 6 is installed;

FIG. 9 is a view for explaining a schematic configuration of a high voltage power supply unit of the microwave introduction unit in the first embodiment of the present invention;

FIG. 10 is a top view showing a surface of a ceiling portion of a process chamber shown in FIG. 1;

FIG. 11 is a view for explaining a structure of a control unit shown in FIG. 1;

FIG. 12 is a cross sectional view showing a schematic configuration of a microwave heating apparatus in accordance with a second embodiment of the present invention;

FIG. 13 is a partial enlarged cross sectional view showing a configuration around a phase control unit of the microwave heating apparatus in accordance with the second embodiment of the present invention;

FIG. 14 is a partial enlarged cross sectional view showing a configuration around the phase control unit in which a movable block is lowered from the state shown in FIG. 13;

FIG. 15 is a cross sectional view showing a schematic configuration of a microwave heating apparatus in accordance with a third embodiment of the present invention;

FIG. 16 is a partial enlarged cross sectional view showing a configuration around a phase control unit of the microwave heating apparatus in accordance with the third embodiment of the present invention;

FIG. 17 is a partial enlarged cross sectional view showing a configuration around the phase control unit in which a movable cylinder is raised from the state shown in FIG. 16;

FIG. 18 is a partial enlarged cross sectional view showing a configuration around a phase control unit of the microwave heating apparatus in accordance with a modification of the third embodiment of the present invention;

FIG. 19 is a partial enlarged cross sectional view showing a configuration around the phase control unit in which the movable cylinder is raised from the state shown in FIG. 18;

FIG. 20 is a cross sectional view showing a schematic configuration of a microwave heating apparatus in accordance with a fourth embodiment of the present invention;

FIG. 21 is a perspective view showing an entire holder in the fourth embodiment of the present invention;

FIG. 22 is a cross sectional view showing a base portion of the holder in the fourth embodiment of the present invention; and

FIG. 23 is a top view showing a bottom portion seen from the inside of the process chamber which is for explaining a modification of the present invention.

### DETAILED DESCRIPTION OF THE EMBODIMENTS

Hereinafter, embodiments of the present invention will be described in detail with reference to the accompanying drawing.

### First Embodiment

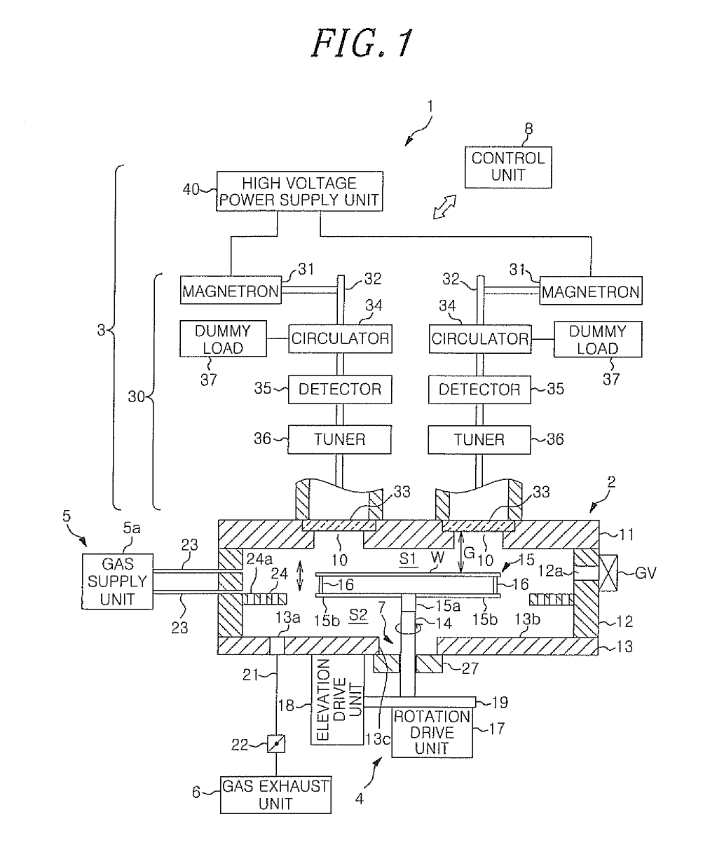

First, a schematic configuration of a microwave heating apparatus in accordance with a first embodiment of the present invention will be described with reference to FIG. 1. FIG. 1 is a cross sectional view showing the schematic configuration of the microwave heating apparatus of the present embodiment. A microwave heating apparatus 1 of the present embodiment performs, through a series of consecutive operations, a heating process by irradiating microwaves to, e.g., a semiconductor wafer (hereinafter, simply referred to as “wafer”) W used for manufacturing semiconductor devices.

The microwave heating apparatus 1 includes: a process chamber 2 for accommodating a wafer W that is an object to be processed; a microwave introduction unit 3 for introducing microwaves into the process chamber 2; a supporting unit 4 for supporting the wafer W in the process chamber 2; a gas supply mechanism 5 for supplying a gas into the process chamber 2; a gas exhaust unit 6 for vacuum-exhausting the process chamber 2; a phase control unit 7 for changing the phases of standing waves of the microwaves introduced into the process chamber 2 by the microwave introduction unit 3; and a control unit 8 for controlling the respective components of the microwave heating apparatus 1.

<Process Chamber>

The process chamber 2 is made of a metal, e.g., aluminum, aluminum alloy, stainless steel or the like.

The process chamber 2 includes: a plate-shaped ceiling portion 11 serving as a top wall; a bottom portion 13 serving as a bottom wall; a square tube-shaped sidewall 12 which connects the ceiling portion 11 and the bottom portion 13; a plurality of microwave introduction ports 10 vertically penetrating through the ceiling portion 11; a loading/unloading port 12a provided at the sidewall 12; and a gas exhaust port 13a provided at the bottom portion 13. The sidewall 12 may be formed in a cylindrical shape. The loading/unloading port 12a allows the wafer W to be transferred between the process chamber 2 and a transfer chamber (not shown) adjacent thereto. A gate valve GV is provided between the process chamber 2 and the transfer chamber. The gate valve GV has a function of opening and closing the loading/unloading port 12a. When the gate valve GV is closed, the process chamber 2 is airtightly sealed. When the gate valve GV is opened, the wafer W can be transferred between the process chamber 2 and the transfer chamber.

<Microwave Introduction Unit>

The microwave introduction unit 3 is provided above the process chamber 2 and serves as a unit for introducing electromagnetic waves (microwaves) into the process chamber 2. The configuration of the microwave introduction unit 3 will be later described in detail.

<Supporting Unit>

The supporting unit 4 includes a tubular shaft 14 and a holder 15. The shaft 14 penetrates through substantially the center of the bottom portion 13 of the process chamber 2 to extend to the outside of the process chamber 2. The holder 15 serving as a supporting unit is attached to the upper end of the shaft 14. The holder 15 has a base portion 15a attached to the upper end of the shaft 14, a plurality of (three in the present embodiment) arms 15b arranged radially from the base portion 15a in a substantially horizontal plane, and a plurality of supporting pins 16 detachably attached to the respective arms 15b. The supporting pins 16 come in contact with the backside of the wafer W to support the wafer W in the process chamber 2. The supporting pins 16 are disposed such that the upper end portions thereof are arranged along the circumferential direction of the wafer W. The supporting pins 16 are detachably attached to the arms 15b, respectively. The number of the arms 15b and the number of the supporting pins 16 are not particularly limited as long as the wafer W can be stably supported. The holder 15 and the supporting pins 16 are made of a dielectric material. As for the dielectric material, it is possible to use, e.g., quartz, ceramic or the like.

Further, the supporting unit 4 includes: a rotation drive unit 17 for rotating the shaft 14; an elevation drive unit 18 for vertically displacing the shaft 14; and a movable connection portion 19 for supporting the shaft 14 and connecting the rotation drive unit 17 and the elevation drive unit 18. The rotation drive unit 17, the elevation drive unit 18 and the movable connection portion 19 are provided at the outside of the process chamber 2. If the inside of the process chamber 2 needs to be in a vacuum state, a seal mechanism (not shown), e.g., a bellows or the like, may be provided around the portion where the shaft 14 penetrates through the bottom portion 13.

In the supporting unit 4, the shaft 14, the holder 15, the rotation drive unit 17 and the movable connection portion 19 constitute a rotation mechanism for rotating, in a horizontal plane, the wafer W supported by the supporting pins 16. By driving the rotation drive unit 17, the supporting pins 16 and the holder 15 are rotated about the shaft 14 to allow each of the supporting pins 16 to be circularly moved (revolved) horizontally. Further, in the supporting unit 4, the shaft 14, the holder 15, the elevation drive unit 18 and the movable connection portion constitute a vertical position control mechanism for controlling a vertical position of the wafer W supported by the supporting pins 16. By driving the elevation drive unit 18, the supporting pins 16 and the holder 15 are vertically displaced together with the shaft 14.

The rotation drive unit 17 is not particularly limited as long as it can rotate the shaft 14. For example, the rotation drive unit 17 may have a motor (not shown) or the like. The elevation drive unit 18 is not particularly limited as long as it can vertically displace the shaft 14 and the movable connection portion 19. For example, the elevation drive unit 18 may have a ball screw (not shown) or the like. The rotation drive unit 17 and the elevation drive unit 18 may be formed as one unit, or the movable connection portion 19 may be omitted. Moreover, the rotation mechanism for rotating the wafer W in a horizontal plane and the vertical position control mechanism for controlling a vertical position of the wafer W may have another configuration as long as the functions thereof can be realized.

<Gas Exhaust Unit>

The gas exhaust unit 6 may have a vacuum pump, e.g., a dry pump or the like. The microwave heating apparatus 1 further includes a gas exhaust line 21 for connecting the gas exhaust port 13a and the gas exhaust unit 6, and a pressure control valve 22 disposed on the gas exhaust line 21. By operating the vacuum pump of the gas exhaust unit 6, the inner space of the process chamber 2 is vacuum-exhausted. Further, the microwave heating apparatus 1 may perform processing under the atmospheric pressure, and in this case, the vacuum pump may be omitted. As for the gas exhaust unit 6, a gas exhaust equipment provided at a facility where the microwave heating apparatus 1 is installed may be used instead of the vacuum pump such as a dry pump or the like.

<Gas Supply Mechanism>

The gas supply mechanism 5 includes: a gas supply unit 5a having a gas supply source (not shown); and a plurality of gas supply lines 23, connected to the gas supply unit 5a, for introducing a process gas into the process chamber 2. The gas supply lines 23 are connected to the sidewall 12 of the process chamber 2.

The gas supply unit 5a is configured to supply a process gas or a cooling gas, e.g., N₂, Ar, He, Ne, O₂, H₂ or the like, into the process chamber 2 through the gas supply lines 23 in a side flow manner. Alternatively, a gas supply means may be provided at a position opposite to the wafer W (e.g., the ceiling portion 11) to supply the gas into the process chamber 2. Moreover, instead of the gas supply unit 5a, an external gas supply unit that is not included in the configuration of the microwave heating apparatus 1 may be used. Although it is not illustrated, the microwave heating apparatus 1 further includes mass flow controllers and opening/closing valves which are provided on the gas supply lines 23. The types or the flow rates of the gases supplied into the process chamber 2 are controlled by the mass flow controllers and the opening/closing valves.

<Rectifying Plate>

The microwave heating apparatus 1 further includes a frame-shaped rectifying plate 24 between the sidewall 12 and the periphery of the supporting pins 16 in the process chamber 2. The rectifying plate 24 has a plurality of rectifying openings 24a provided to vertically penetrate the rectifying plate 24. The rectifying plate 24 allows the gas to flow toward the gas exhaust port 13a while rectifying an atmosphere in an area where the wafer W is disposed in the process chamber 2. The rectifying plate 24 is made of a metal, e.g., aluminum, aluminum alloy, stainless steel or the like. Further, the rectifying plate 24 is not an essential component for the microwave heating apparatus 1 and thus may not be provided.

<Temperature Measurement Unit>

Although it is not illustrated, the microwave heating apparatus 1 further includes a plurality of radiation thermometers for measuring a surface temperature of the wafer W, and a temperature measurement unit connected to the radiation thermometers.

<Microwave Radiation Space>

In the microwave heating apparatus 1 of the present embodiment, a space defined by the ceiling portion 11, the sidewall 12 and the rectifying plate 24 in the process chamber 2 forms a microwave radiation space S1. Microwaves are radiated into the microwave radiation space S1 through the microwave introduction ports 10 provided at the ceiling portion 11. Since all of the ceiling portion 11, the sidewall 12 and the rectifying plate 24 of the process chamber 2 are made of a metal, the microwaves are reflected and scattered in the microwave radiation space S1 to generate the standing waves. The microwaves introduced into the process chamber 2 generate the standing waves also in a space S2 between the bottom portion 13 and the wafer W.

<Phase Control Unit>

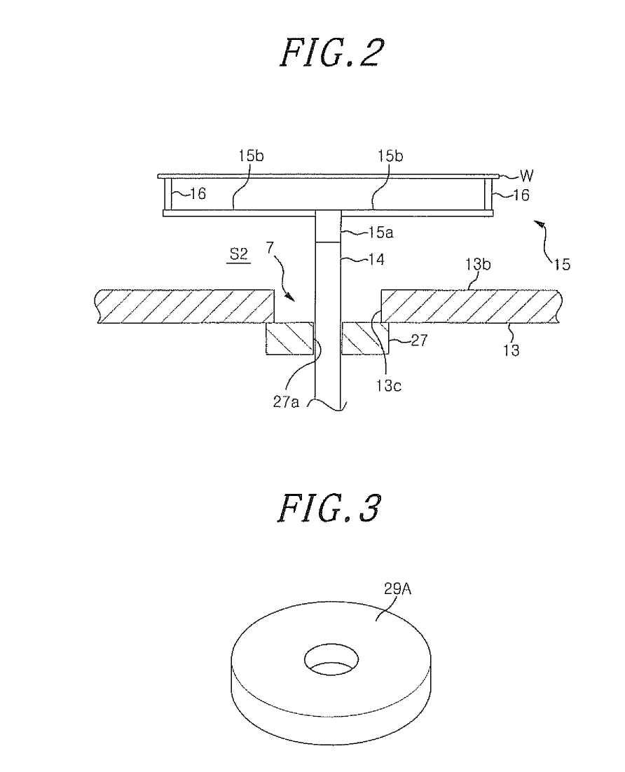

Hereinafter, a phase control unit for changing the phases of the standing waves will be described in detail with reference to FIGS. 2 to 8. First, FIG. 2 is a partial enlarged cross sectional view showing the configuration around the phase control unit 7 in the microwave heating apparatus 1 of the present embodiment. The phase control unit 7 changes the phases of the standing waves of the microwaves introduced into the process chamber 2 by the microwave introduction unit 3. Preferably, the phase control unit 7 is disposed below the wafer W supported by the supporting pins 16 in view of achieving uniform radiation of the microwave in the diametrical direction of the wafer W. Specifically, at least a part of the phase control unit 7, preferably the entire phase control unit 7, is disposed so as to overlap vertically with the wafer W supported by the supporting pins 16.

Referring to FIG. 2, the phase control unit 7 has a recessed portion with respect to the inner surface 13b of the bottom portion 13 of the process chamber 2. The phase control unit 7 is formed by the bottom portion 13 and a fixing plate 27 which is installed at the lower surface of the bottom portion 13 from the outside of the process chamber 2. An opening 13c is formed at the center of the bottom portion 13. The fixing plate 27 is installed so as to block the opening 13c from the outside of the process chamber 2, thereby forming the phase control unit 7. The fixing plate 27 is a metal plate having, at the center thereof, an opening 27a through which the shaft 14 can be inserted. The fixing plate 27 is fixed to the bottom portion 13 by a fixing unit (not shown) such as a screw or the like. The shaft 14 is inserted through the openings 13c and 27a. An electromagnetic wave shield (not shown) for preventing leakage of the microwave is provided between the fixing plate 27 and the bottom portion 13 and between the fixing plate 27 and the shaft 14. In addition, a vacuum seal member for ensuring airtightness in the process chamber 2 may be provided between the fixing plate 27 and the bottom portion 13 and between the fixing plate 27 and the shaft 14, if necessary.

The phase control unit 7 changes the phases of the standing waves of the microwaves introduced into the process chamber 2 by the microwave introduction unit 3. The phase control unit 7 is made of a metallic wall for reflecting the microwaves. In other words, the recessed portion of the phase control unit 7 is formed by the metallic bottom portion 13 and the metallic fixing plate 27. The phases of the standing waves in the process chamber 2 can be changed by the incidence and reflection of the microwaves in the recessed portion of the phase control unit 7 surrounded by the metallic wall. When the phase control unit 7 having the recessed portion is provided, the standing waves can be easily shifted compared to when the inner surface 13b of the bottom portion 13 is flat. Moreover, in the microwave heating apparatus 1 of the present embodiment, the surface of the wafer W can be uniformly heated by controlling the phases of the standing waves in the process chamber by changing the depth or the inner diameter of the recessed portion in the phase control unit 7. For variably changing the depth and/or the inner diameter of the recessed portion of the phase control unit 7, an auxiliary member can be used in the present embodiment.

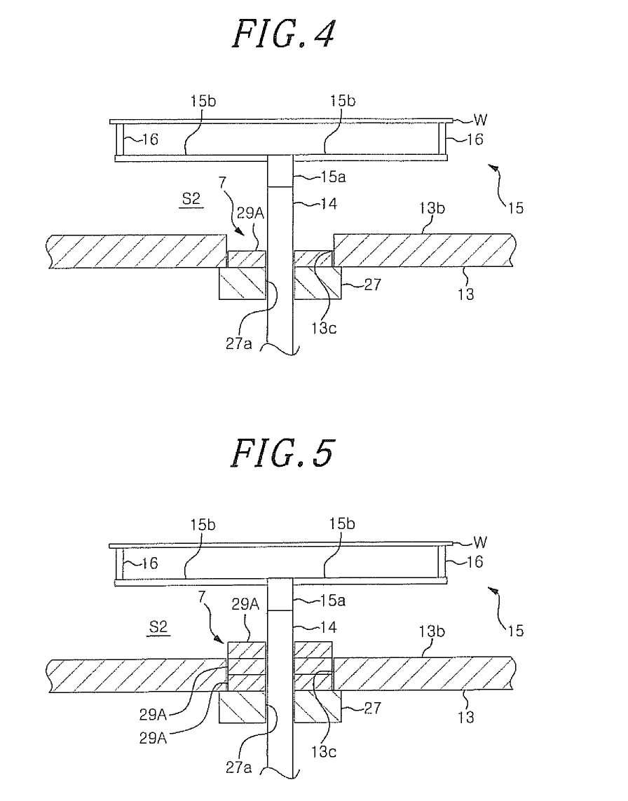

Hereinafter, examples of the phase control unit 7 having the auxiliary member will be described with reference to FIGS. 3 to 8. In the present embodiment, one or more fitting plates are used as the auxiliary member. FIG. 3 is a perspective view showing an entire structure of a fitting plate 29A as an example of the auxiliary member. FIG. 4 is a partial enlarged cross sectional view showing the configuration around the phase control unit 7 to which the fitting plate 29A is installed. FIG. 5 is a partial enlarged cross sectional view showing the configuration around the phase control unit 7 to which three stacked fitting plates 29A are installed. The fitting plate 29A is a ring-shaped metallic member. The outer diameter of the fitting plate 29A is slightly smaller than the inner diameter of the opening 13c so that the fitting plate 29A can be inserted in the opening 13c. The inner diameter of the ring-shaped fitting plate 29A is slightly greater than the shaft 14.

Referring to FIG. 4, one fitting plate 29A is inserted in the recessed portion of the phase control unit 7. As illustrated, the ring-shaped fitting plate 29A is located in the recessed portion of the phase control unit 7 in a state where the shaft 14 is inserted through the fitting plate 29A. In the example shown in FIG. 4, the height of the fitting plate 29A is substantially a half of the thickness of the bottom portion 13. Therefore, the depth of the recessed portion of the phase control unit 7 is reduced to substantially a half by installing the fitting plate 29A.

Referring to FIG. 5, vertically stacked three fitting plates 29A are inserted in the recessed portion of the phase control unit 7. As illustrated, the ring-shaped fitting plates 29A are located at the recessed portion of the phase control unit 7 in a state where the shaft 14 is inserted. In the example shown in FIG. 5, the height of each of the fitting plates 29A is about a half of the thickness of the bottom portion 13. The total height of the three stacked fitting plates 29A becomes higher than the inner surface 13b of the bottom portion 13. In other words, the phase control unit 7 has a protruded portion with respect to the inner surface 13b of the bottom portion 13 due to the three stacked fitting plates 29A. In this manner, the phase control unit 7 may have the protruded portion instead of the recessed portion. The phases of the standing waves in the space S2 can be changed by the reflection from the protruded portion formed by the metallic fitting plates 29A.

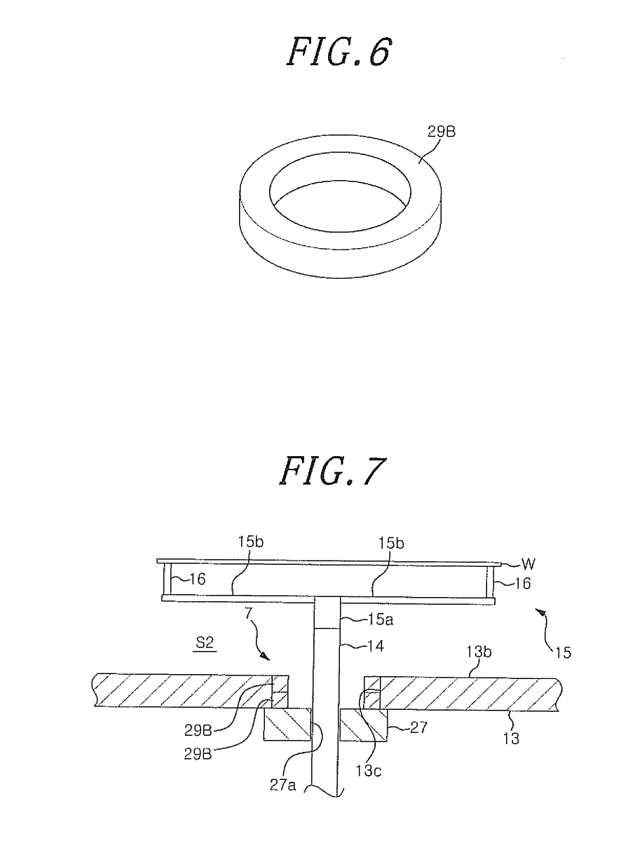

FIG. 6 is a perspective view showing an entire structure of a fitting plate 29B as another example of the auxiliary member. FIG. 7 is a partial enlarged cross sectional view showing the configuration around the phase control unit 7 to which the fitting plate 29B is installed. The fitting plate 29B is a ring-shaped metallic member. The outer diameter of the fitting plate 29B is slightly smaller than the inner diameter of the opening 13c so that the fitting plate 29B can be inserted in the opening 13c. The inner diameter of the ring-shaped fitting plate 29B is sufficiently greater, e.g., about 4 to 5 times greater than the diameter of the shaft 14.

Referring to FIG. 7, vertically stacked two fitting plates 29B are inserted in the recessed portion of the phase control unit 7. In the example shown in FIG. 7, the height of each of the fitting plates 29B is about a half of the thickness of the bottom portion 13. Therefore, the total height of the two stacked fitting plates 29B becomes equal to the height of the inner surface 13b of the bottom portion 13. Further, the inner diameter of the ring-shaped fitting plate 29B is greater than that of the fitting plate 29A shown in FIG. 3. Therefore, even in a state where the fitting plate 29B is inserted in the recessed portion of the phase control unit 7, a recessed portion is formed around the shaft 14. By installing two stacked fitting plates 29B as described above, the inner diameter of the recessed portion of the phase control unit 7 can be substantially reduced. In addition, two or more fitting plates 29B may be arranged inside and outside of each other. For example, the diameter of the recessed portion of the phase control unit 7 can be further reduced by installing, at the inside of the fitting plate 29B, a ring-shaped fitting plate having a diameter smaller than that of the fitting plate 29B.

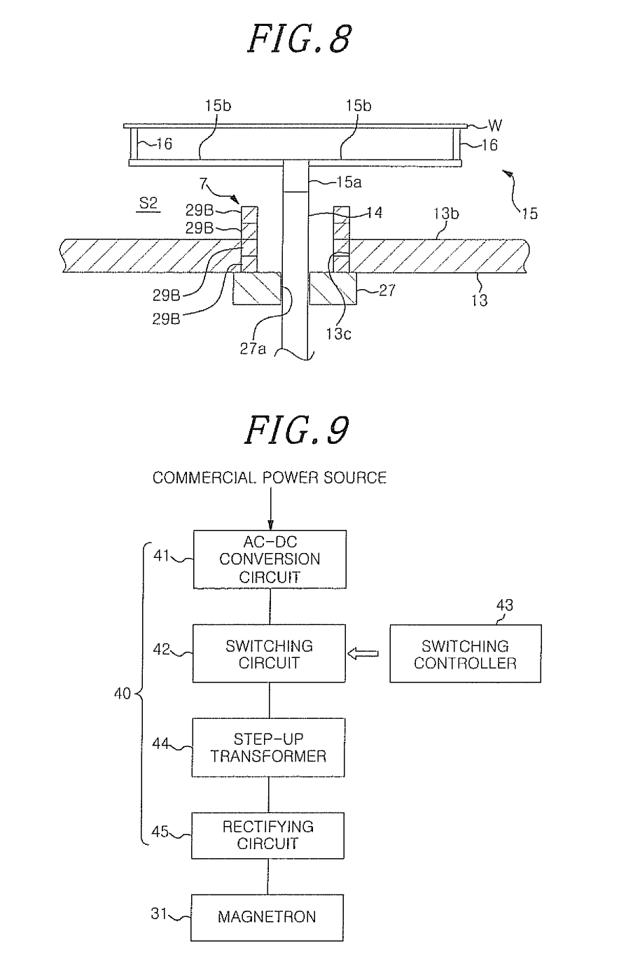

FIG. 8 is a partial enlarged cross sectional view showing the configuration around the phase control unit 7 to which the fitting plates 29B are installed. In FIG. 8, vertically stacked four fitting plates 29B are inserted in an opening 13C of the bottom portion 13. In the example shown in FIG. 8, the height of each of the fitting plates 29B is about a half of the thickness of the bottom portion 13, so that the total height of the four stacked fitting plates 29B is about twice the thickness of the bottom portion 13. In other words, the phase control unit 7 has a portion protruding toward the space S2 due to the four fitting plates 29B. Further, even in a state where the ring-shaped fitting plate 29B is inserted in the opening 13c, a recessed portion is formed around the shaft 14. By installing four stacked fitting plates 29B as described above, it is substantially possible to reduce the inner diameter of the recessed portion of the phase control unit 7 and, increase the depth of the recessed portion.

The thickness, the width, the inner diameter, the outer diameter and the like of the fitting plate are not particularly limited. The fitting plate may be formed in, e.g., a polygonal frame shape such as a triangle, a quadrangle or the like, or a cylindrical shape. Moreover, the fitting plate may be, e.g., divided into a plurality of parts that forms as a whole a ring shape, a frame shape or a cylindrical shape. In addition, several types of fitting plates having different shapes that are combined may be used.

<Microwave Introduction Unit>

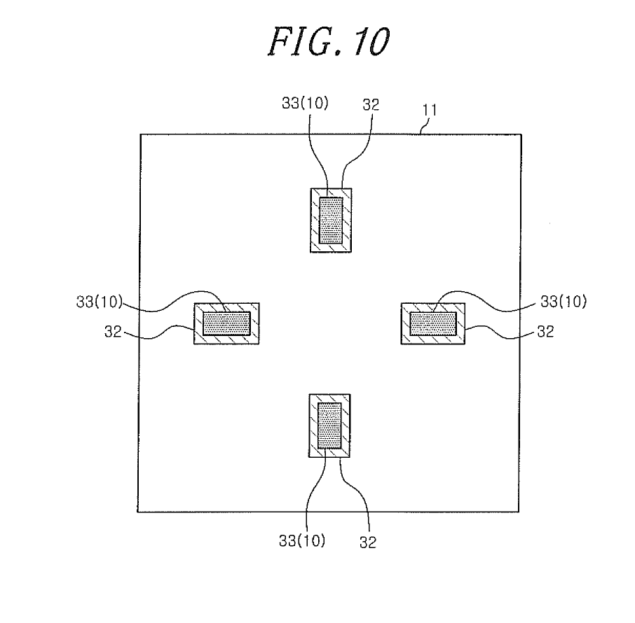

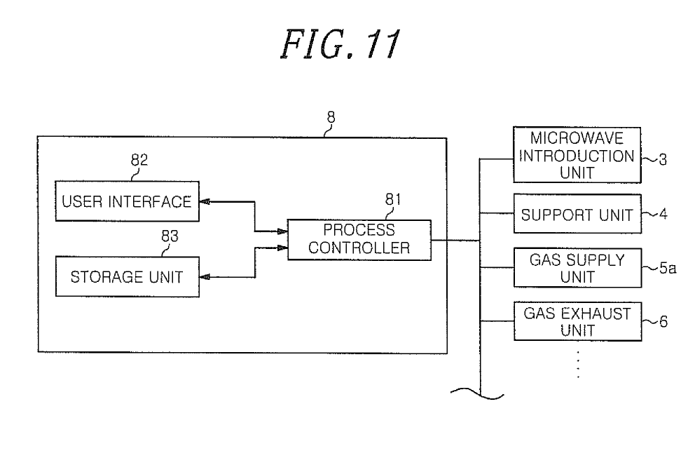

Hereinafter, the configuration of the microwave introduction unit 3 will be described with reference to FIGS. 1, 9 and 10. FIG. 9 is a view for explaining a schematic configuration of a high voltage power supply unit of the microwave introduction unit 3. FIG. 10 is a top view showing a surface of the ceiling portion 11 of the process chamber 2 shown in FIG. 1.

As described above, the microwave introduction unit 3 is provided above the process chamber 2 and introduces microwaves into the process chamber 2. As shown in FIG. 1, the microwave introduction unit 3 includes a plurality of microwave units 30 for introducing microwaves into the process chamber 2, and a high voltage power supply unit 40 connected to the microwave units 30.

(Microwave Unit)

In the present embodiment, each of the microwave units 30 has the same configuration. Each of the microwave units 30 includes: a magnetron 31 for generating microwaves for processing the wafer W; a waveguide 32 through which the microwaves generated by the magnetron 31 are transmitted to the process chamber 2; and a transmitting window 33 that is fixed to the ceiling portion 11 to cover the microwave introduction ports 10. The magnetron 31 serves as a microwave source in the present embodiment.

As shown in FIG. 10, in the present embodiment, the process chamber 2 has four microwave introduction ports 10 that are spaced apart from each other at a regular interval along the circumferential direction so as to form a substantially cross shape at the ceiling portion 11. Each of the microwave introduction ports 10 is formed in a rectangular shape having shorts sides and long sides when seen from the top. Although the microwave introduction ports 10 may have different sizes or different ratios between the long sides and the short sides, it is preferable that all the four microwave introduction ports 10 have the same size and the same shape in order to increase the uniformity and controllability of the heating process for the wafer W. In the present embodiment, the microwave units 30 are respectively connected to the microwave introduction ports 10. In other words, the number of the microwave units 30 is four. The arrangement of the microwave introduction ports 10 may vary without being limited to that shown in FIG. 10. The number of the microwave units 30 (the number of the magnetrons 31) or the number of the microwave introduction ports 10 is not limited to four.

The magnetron 31 has an anode and a cathode (both not shown) to which a high voltage supplied by the high voltage power supply unit 40 is applied. As for the magnetron 31, one capable of oscillating microwaves of various frequencies may be used. As for the frequency of the microwaves generated by the magnetron 31, an optimal frequency for the processing of an object is selected. For example, in a heating process, the microwaves having a high frequency of 2.45 GHz, 5.8 GHz or the like are preferably used and more preferably, the microwaves having a frequency of 5.8 GHz are used.

The waveguide 32 has a tubular shape with a rectangular cross section and extends upward from the top surface of the ceiling portion 11 of the process chamber 2. The magnetron 31 is connected to an upper end portion of the waveguide 32. A lower end of the waveguide 32 comes into contact with the top surface of the transmitting window 33. The microwaves generated by the magnetron 31 are introduced into the process chamber 2 through the waveguide 32 and the transmitting window 33.

The transmitting window 33 is made of a dielectric material, e.g., quartz, ceramic or the like. The space between the transmitting window 33 and the ceiling portion 11 is airtightly sealed by a sealing member (not shown). A distance (gap G) from the bottom surface of the transmitting window 33 to the surface of the wafer W supported by the supporting pins 14 is preferably set to, e.g., about 25 mm or more and more preferably set within a range from about 25 mm to 50 mm, in view of suppressing direct irradiation of the microwaves to the wafer W.

The microwave unit 30 further includes a circulator 34, a detector 35, and a tuner 36 which are provided on the waveguide 32; and a dummy load 37 connected to the circulator 34. The circulator 34, the detector 35 and the tuner 36 are provided in that order from the upper end side of the waveguide 32. The circulator 34 and the dummy load 37 serve as an isolator for separating reflected waves from the process chamber 2. In other words, the circulator 34 transmits the reflected waves from the process chamber 2 to the dummy load 37, and the dummy load 37 converts the reflected waves transmitted by the circulator 34 into heat.

The detector 35 detects the reflected waves from the process chamber 2 in the waveguide 32. The detector 35 includes, e.g., an impedance monitor, specifically a standing wave monitor for detecting an electric field of the standing wave in the waveguide 32. The standing waves monitor may include, e.g., three pins protruding into the inner space of the waveguide 32. The standing waves monitor detects a location, a phase and an intensity of the electric field of the standing waves, thereby detecting the reflected waves from the process chamber 2. Further, the detector 35 may include a directional coupler capable of detecting traveling waves and reflected waves.

The tuner 36 has a function of matching an impedance between the magnetron 31 and the process chamber 2. The impedance matching by the tuner 36 is performed based on the detection result of the reflected waves by the detector 35. The tuner 36 may include, e.g., a conductor plate (not shown) provided to protrude into and retract from the inner space of the waveguide 32. In that case, by controlling the protruding amount of the conductor plate into the inner space of the waveguide 32, the power amount of the reflected wave can be adjusted and, further, the impedance between the magnetron 31 and the process chamber 2 can be adjusted.

(High Voltage Power Supply Unit)

The high voltage power supply unit 40 supplies a high voltage for generating microwaves to the magnetron 31. As shown in FIG. 9, the high voltage power supply unit 40 includes an AC-DC conversion circuit 41 connected to a commercial power source; a switching circuit 42 connected to the AC-DC conversion circuit 41; a switching controller 43 for controlling an operation of the switching circuit 42; a step-up transformer 44 connected to the switching circuit 42; and a rectifying circuit 45 connected to the step-up transformer 44. The magnetron 31 is connected to the step-up transformer 44 via the rectifying circuit 45.

The AC-DC conversion circuit 41 is a circuit which rectifies AC (e.g., three-phase 200VAC) from the commercial power source and converts it into DC of a predetermined waveform. The switching circuit 42 controls on/off of the DC converted by the AC-DC conversion circuit 41. In the switching circuit 42, the switching controller 43 performs phase-shift PWM (Pulse Width Modulation) control or PAM (Pulse Amplitude Modulation) control to generate a pulse-shaped voltage waveform. The step-up transformer 44 boosts the voltage waveform outputted from the switching circuit 42 to a predetermined level. The rectifying circuit 45 rectifies the voltage boosted by the step-up transformer 44 and supplies the rectified voltage to the magnetron 31.

<Control Unit>

Each of the components of the microwave heating apparatus 1 is connected to the control unit 8 and controlled by the control unit 8. The control unit 8 is typically a computer. FIG. 11 is a view for explaining a configuration of the control unit 8 shown in FIG. 1. In the example shown in FIG. 11, the control unit 8 includes a process controller 81 having a CPU; and a user interface 82 and a storage unit 83 which are connected to the process controller 81.

The process controller 81 performs integrated control of the components (e.g., the microwave introduction unit 3, the supporting unit 4, the gas supply unit 5a, the gas exhaust unit 6 and the like) of the microwave heating apparatus 1 that are related to the process conditions such as a temperature, a pressure, a gas flow rate, power of a microwave, a rotation speed of the wafer W and the like.

The user interface 82 includes a keyboard or a touch panel through which a process manager inputs commands to operate the microwave heating apparatus 1; a display for visually displaying the operation status of the microwave heating apparatus 1; and the like.

The storage unit 83 stores therein control programs (software) for realizing various processes to be performed by the microwave heating apparatus 1 under the control of the process controller 51; and recipes including process condition data and the like. The process controller 81 retrieves and executes a control program and a recipe from the storage unit 83 when necessary, e.g., in accordance with an instruction from the user interface 82. Accordingly, a desired process is performed in the process chamber 2 of the microwave heating apparatus 1 under the control of the process controller 81.

The control programs and the recipes may be stored in a computer-readable storage medium, e.g., a CD-ROM, a hard disk, a flexible disk, a flash memory, a DVD, a Blu-ray disc or the like. Further, the recipes may be transmitted on-line from another device through, e.g., a dedicated line, when necessary.

<Effects>

Hereinafter, the functional effects of the microwave heating apparatus 1 of the present embodiment will be described. As described above, the microwave heating apparatus 1 includes the phase control unit 7. The microwaves introduced into the process chamber 2 through the microwave introduction ports 10 generate standing waves in the space S2 between the wafer W and the bottom portion 13 of the process chamber 2. In the microwave heating apparatus 1 of the present embodiment, the phase control unit 7 for changing the phases of the standing waves is provided at the space S2 or at a position facing the space S2, so that the phases of the standing waves in the space S2 can be changed. Further, by using the fitting plate as an auxiliary member, the phases of the standing waves in the space S2 can be optimized even if, e.g., the arrangement or the number of the microwave introduction ports 10 is changed. Accordingly, a uniform radiation of the microwaves is obtained over the surface of the wafer W, especially in the diametrical direction of the wafer W, thereby realizing a uniform heating. Further, by changing the state of the standing waves in the space S2, the phases of the standing waves in the space S1 is also changed.

In the present embodiment, the heating process is performed while the wafer W supported by the supporting pins 16 is horizontally rotated at a predetermined speed by driving the rotation drive unit 17. As a consequence, over the surface of the wafer W, the radiation of the microwaves in the circumferential direction becomes uniform. Accordingly, the heating process can be uniformly performed even in the circumferential direction over the surface of the wafer W.

[Processing Sequence]

Hereinafter, a processing sequence for heating a wafer W in the microwave heating apparatus 1 will be described. First, a command for performing a heating process in the microwave heating apparatus 1 is inputted from the user interface 82 to the process controller 81. Next, the process controller 81 receives the command and reads out the recipes that have been stored in the storage unit 83 or the computer-readable storage medium. Then, the process controller 81 transmits control signals to the end devices (e.g., the microwave introduction unit 3, the supporting unit 4, the gas supply unit 5a, the gas exhaust unit 6 and the like) of the microwave heating apparatus 1 such that the heating process is performed under the conditions based on the recipes.

Next, the gate valve GV is opened, and the wafer W is loaded into the process chamber 2 through the gate valve GV and the loading/unloading port 12a by a transfer unit (not shown). The wafer W is mounted on the supporting pins 16. The elevation drive unit 18 is driven, so that the supporting pins 16 are vertically moved together with the shaft 14 and the holder 15 to set the wafer W to a predetermined height. Then, at this height, it is preferable to rotate the wafer W horizontally at a predetermined speed by driving the rotation drive unit 17, if necessary. The wafer W may not be rotated continuously, i.e., may be rotated discontinuously. Thereafter, the gate valve GV is closed, and the process chamber 2 is vacuum-evacuated by the gas exhaust unit 6, if necessary. Next, a processing gas is introduced at a predetermined flow rate into the process chamber 2 by the gas supply unit 5a. The inner space of the process chamber 2 is controlled to a predetermined pressure by adjusting a gas exhaust amount and a gas supply amount.

Thereafter, microwaves are generated by applying a voltage from the high voltage power supply unit 40 to the magnetron 31. The microwaves generated by the magnetron 31 are transmitted through the waveguide 32 and the transmitting window 33, and introduced into a space above the wafer W in the process chamber 2. For example, microwaves are sequentially generated by the magnetrons 31 and introduced alternately into the process chamber 2 through each of the microwave introduction ports 10. Alternatively, the microwaves may be simultaneously generated by the magnetrons 31 and simultaneously introduced into the process chamber 2 through the microwave introduction ports 10.

The microwaves introduced into the process chamber 2 are radiated to the wafer W, and the wafer W is rapidly heated by electromagnetic wave heat such as Joule heat, magnetic heat, inductive heat or the like. As a result, the heating process is performed on the wafer W. In the microwave heating apparatus 1 of the present embodiment, the phases of the standing waves in the spaces S1 and S2 can be changed by the phase control unit 7, so that the uniform heating over the surface of the wafer W can be realized. When the wafer W is rotated during the heating process, the heating temperature over the surface of the wafer W can be more uniform by reducing the deviation of the microwaves in the circumferential direction of the wafer W. Further, the height of the wafer W can be changed by driving the elevation drive unit 18 during the heating process.

When a control signal for terminating the heating process is transmitted from the process controller 81 to the end devices of the microwave heating apparatus 1, the generation of the microwaves is stopped and the supply of the processing gas and the cooling gas is stopped. In this manner, the heating process for the wafer W is terminated. Next, the gate valve GV is opened, the height of the wafer W on the supporting pins 16 is adjusted and then the wafer W is unloaded by the transfer unit (not shown).

The microwave heating apparatus 1 is preferably used for, e.g., a heating process for activating doping atoms implanted into the diffusion layer in the manufacturing process of semiconductor devices.

As described above, in the microwave hating apparatus 1 and the heating method of the present embodiment, the phase control unit 7 is provided to make the absorption of the microwaves uniform over the surface of the wafer W, thereby improving the heating efficiency. In the case of heating the wafer W while rotating the wafer W horizontally at a predetermined speed, the absorption of the microwaves becomes more uniform over the surface of the wafer W. Hence, in accordance with the microwave heating apparatus 1 and the heating method of the present embodiment, the heating process can be performed on the wafer W effectively and uniformly over the surface of the wafer W.

### Second Embodiment

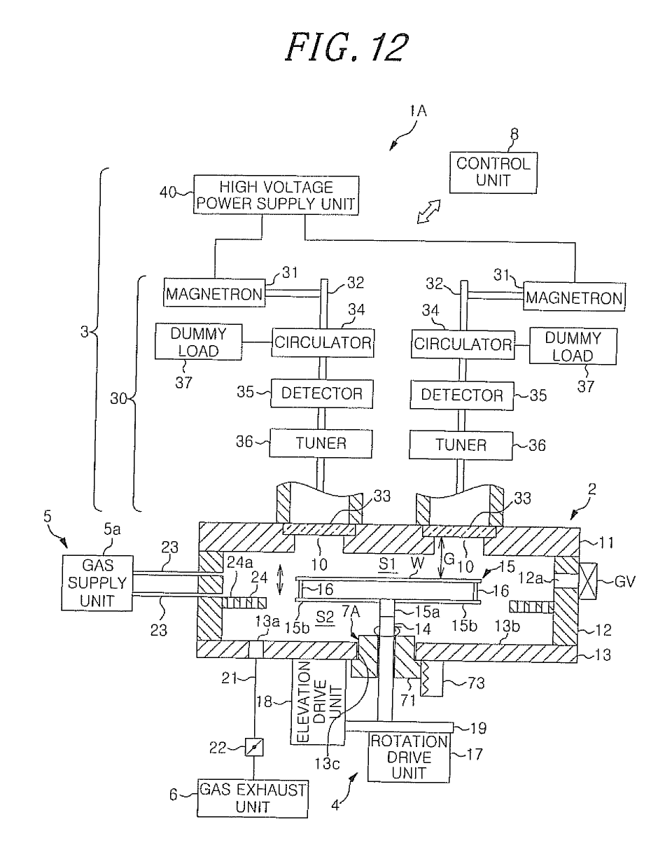

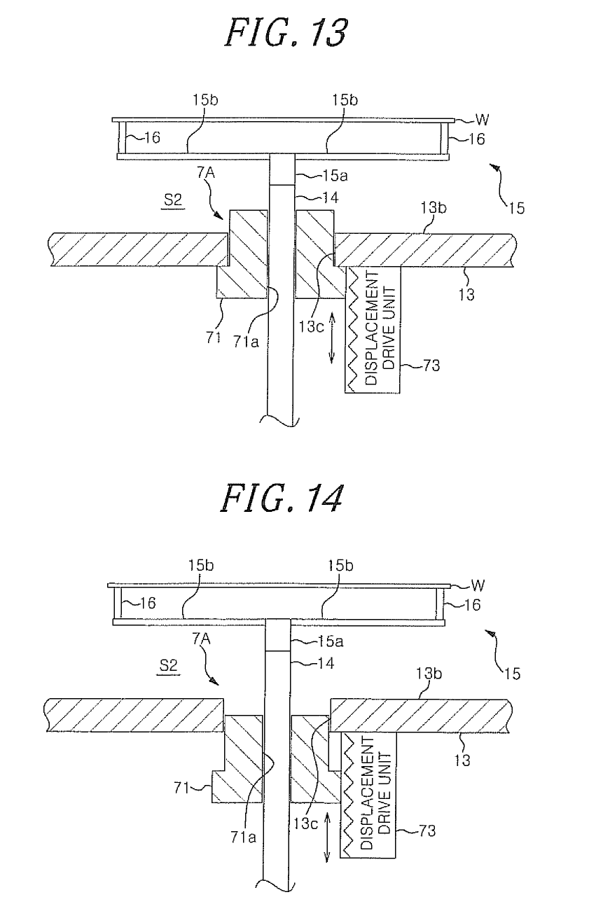

A microwave heating apparatus in accordance with a second embodiment of the present invention will be described with reference to FIGS. 12 to 14. FIG. 12 is a cross sectional view showing a schematic configuration of a microwave heating apparatus 1A of the present embodiment. FIGS. 13 and 14 are partial enlarged cross sectional views showing configurations around a phase control unit in the microwave heating apparatus 1A of the present embodiment. The microwave heating apparatus 1A of the present embodiment performs a heating process by irradiating microwaves to, e.g., a wafer W, through a plurality of consecutive operations. In the following description, differences between the microwave heating apparatus 1 of the first embodiment and the microwave heating apparatus 1A of the present embodiment will be mainly described. In FIGS. 12 to 14, like reference numerals will be used for like parts as those of the microwave heating apparatus 1 of the first embodiment, and redundant description will be omitted.

The microwave heating apparatus 1A of the present embodiment includes: a process chamber 2 for accommodating therein a wafer W; a microwave introduction unit 3 for introducing microwaves into the process chamber 2; a supporting unit 4 for supporting the wafer W in the process chamber 2; a gas supply mechanism 5 for supplying a gas into the process chamber 2; a gas exhaust unit 6 for vacuum-exhausting the process chamber 2; a phase control unit 7A for changing the phase of standing waves of the microwaves introduced into the process chamber 2 by the microwave introduction unit 3; and a control unit 8 for controlling the respective components of the microwave heating apparatus 1A.

<Phase Control Unit>

The phase control unit 7A of the microwave heating apparatus 1A of the present embodiment includes: a movable block 71 that is a movable member installed at the bottom portion 13 of the process chamber 2 so as to protrude into and retract from the space S2 in the process chamber 2; and a displacement drive unit 73 for vertically displacing the movable block 71. The displacement drive unit 73 includes a driving mechanism, e.g., a ball screw, a rack and pinion, an air cylinder, a hydraulic cylinder or the like.

The phase control unit 7A changes the phases of the standing waves of the microwaves introduced into the process chamber 2 by the microwave introduction unit 3. The phase control unit 7A is provided below the wafer W supported by the supporting pins 16 in order to easily obtain uniform radiation of the microwaves in the diametrical direction of the wafer W. Specifically, at least a part of the phase control unit 7A is disposed to vertically overlap with the wafer W supported by the supporting pins 16.

An opening 13c is formed at the center of the bottom portion 13, and the movable block 71 is attached to block the opening 13c from the outside of the process chamber 2. The movable block 71 is a cylindrical metallic member having at a central portion thereof an opening 71a through which the shaft 14 can be inserted. The outer diameter of an upper portion of the movable block 71 is slightly smaller than the inner diameter of the opening 13c so that the upper portion of the movable block 71 can be inserted through the opening 13c. The inner diameter of the opening 71a of the cylindrical movable block 71 is slightly greater than the shaft 14.

The movable block 71 is connected to the displacement drive unit 73 and thus can be vertically displaced by a predetermined stroke by driving the displacement drive unit 73. An electromagnetic wave shield member (not shown) for preventing leakage of microwaves is provided between the movable block 71 and the bottom portion 13 and between the movable block 71 and the shaft 14. Further, a vacuum seal member for ensuring airtightness in the process chamber 2 may be provided between the movable block 71 and the bottom portion 13 and between the movable block 71 and the shaft 14, if necessary.

FIG. 13 shows a state in which the movable block 71 is raised. The upper end of the movable block 71 that has been raised is higher than the inner surface 13b of the bottom portion 13 and protrudes into the space S2 of the process chamber 2. As shown in FIG. 13, in the state where the movable block 71 is raised, the phase control unit 7A has a protruded portion protruding into the process chamber 2 with respect to the inner surface 13b of the bottom portion 13. The movable block 71 is made of a metal for reflecting the microwaves. In the state where the movable block 71 is raised, the microwaves are reflected by the protruded portion of the metallic movable block 71, so that the phases of the standing waves in the process chamber 2 can be changed. In other words, by the phase control unit 7A having the protruded portion of the movable block 71, the position of the standing waves can be shifted compared to a case where the inner surface 13b of the bottom portion 13 is flat.

FIG. 14 shows a state in which the movable block 71 is lowered. The upper end of the movable block 71 is retracted to a position lower than the inner surface 13b of the bottom portion 13. In the state where the movable block 71 is lowered, the phase control unit 7A has a recessed portion with respect to the inner surface 13b of the bottom portion 13. The movable block 71 and the bottom portion 13 are made of a metal for reflecting the microwaves. In the state where the movable block 71 is lowered to the position shown in FIG. 14, the phases of the standing waves in the process chamber 2 can be changed by the incidence and reflection of the microwaves in the recessed portion of the phase control unit 7A surrounded by the metallic wall. In other words, by the phase control unit 7A having the recessed portion formed by the movable block 71, the position of the standing waves can be shifted compared to the case where the inner surface 13b of the bottom portion 13 is flat.

In the microwave heating apparatus 1A of the present embodiment, the position of the movable block 71 may be fixed or may be displaced continuously or discontinuously during the heating process. By vertically displacing the movable block 71 continuously or discontinuously during the heating process, the height of the protruded portion or the depth of the recessed portion of the phase control unit 7A can be changed. By changing the height of the protruded portion or the depth of the recessed portion of the phase control unit 7A during the heating process, the phases of the standing waves in the process chamber 2 can be controlled and, further, uniform heating over the surface of the wafer W can be realized.

In the microwave heating apparatus 1A of the present embodiment, the phase control unit 7A for changing the phases of the standing waves is provided at the space S2 or the position facing the space S2, so that the phases of the standing waves in the space S2 can be changed. Further, the phases of the standing waves in the process chamber 2 can be controlled by changing the height of the protruded portion or the depth of the recessed portion by displacing the movable block 71 of the phase control unit 7A. Therefore, the uniform heating over the surface of the wafer W can be achieved. Furthermore, by changing the states of the standing waves in the space S2, the phases of the standing waves in the space S1 is also changed.

The movable block 71 may be formed in, e.g., a polygonal tube shape such as a triangular tube shape, a square tube shape or the like. In addition, the movable block 71 may be, e.g., divided into a plurality of parts that forms as a whole the tube shape.

The other configurations and effects of the microwave heating apparatus 1A of the present embodiment are the same as those of the microwave heating apparatus 1 of the first embodiment, so that the redundant description thereof will be omitted.

### Third Embodiment

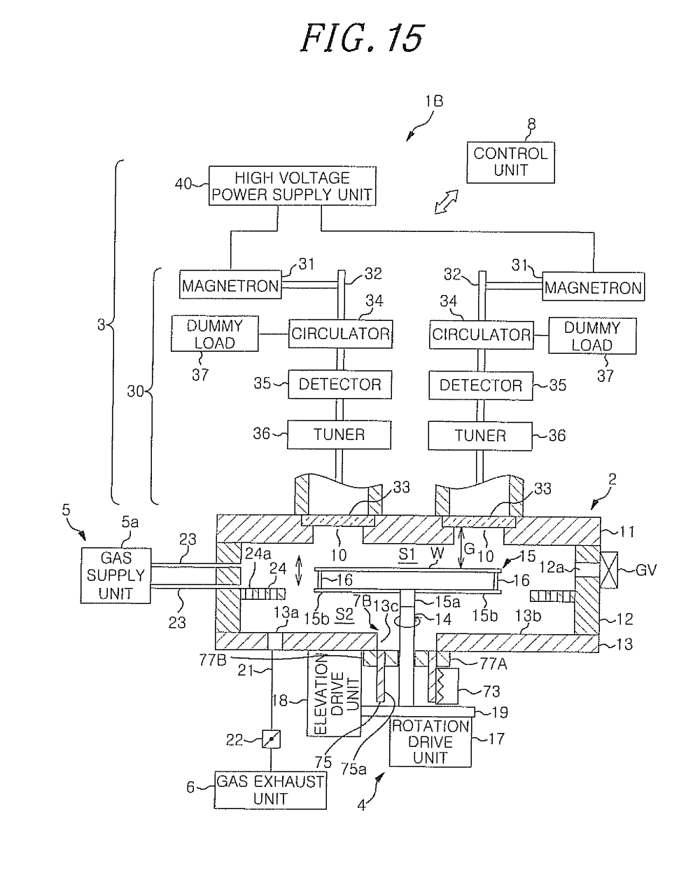

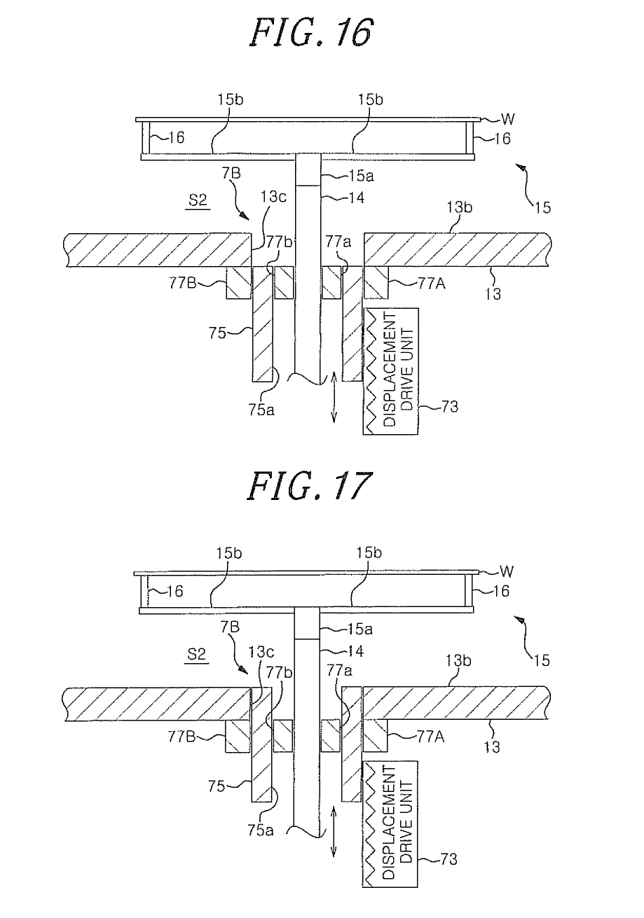

Hereinafter, a microwave heating apparatus 1B in accordance with a third embodiment of the present invention will be described with reference to FIGS. 15 to 17. FIG. 15 is a cross sectional view showing a schematic configuration of a microwave heating apparatus 1B of the present embodiment. FIGS. 16 and 17 are partial enlarged cross sectional views showing a configuration around a phase control unit in the microwave heating apparatus 1B of the present embodiment. The microwave heating apparatus 1B of the present embodiment performs a heating process by irradiating microwaves to, e.g., a wafer W, through a plurality of consecutive operations. In the following description, differences between the microwave heating apparatus 1 of the first embodiment and the microwave heating apparatus 1B of the present embodiment will be described. In FIGS. 15 to 17, like reference numerals will be used for like parts as those of the microwave heating apparatus 1 of the first embodiment, and redundant description will be omitted.

The microwave heating apparatus 1B of the present embodiment includes: a process chamber 2 for accommodating therein a wafer W; a microwave introduction unit 3 for introducing microwaves into the process chamber 2; a supporting unit 4 for supporting the wafer W in the process chamber 2; a gas supply mechanism 5 for supplying a gas into the process chamber 2; a gas exhaust unit 6 for vacuum-exhausting the process chamber 2; a phase control unit 7B for changing the phases of standing waves of the microwaves introduced into the process chamber 2 by the microwave introduction unit 3; and a control unit 8 for controlling the respective components of the microwave heating apparatus 1B.

<Phase Control Unit>

The phase control unit 7B of the microwave heating apparatus 1B of the present embodiment includes: a movable cylinder 75 that is a movable member installed at the bottom portion 13 of the process chamber 2 to protrude into and retract from the space S2 in the process chamber 2; a displacement drive unit 73 for vertically displacing the movable cylinder 75; and fixing plates 77A and 77B attached to the lower surface of the bottom portion 13 from the outside of the process chamber 2. The fixing plate 77A is a metallic half tubular member having an opening 77a through which the movable cylinder 75 can be inserted. The fixing plate 77B is a metallic half tubular member having an opening 77b through which the movable cylinder 75 can be inserted. The fixing plates 77A and 77B are fixed to the bottom portion 13 by a fixing device (not shown) such as a screw or the like. Further, the configuration of the displacement drive unit 73 is the same as that of the second embodiment.

The phase control unit 7B changes the phases of the standing waves of the microwaves introduced into the process chamber 2 by the microwave introduction unit 3. The phase control unit 7B is disposed below the wafer W supported by the supporting pins 16 in order to easily obtain uniform radiation of the microwaves in the diametrical direction of the wafer W. Specifically, at least a part of the phase control unit 7B is disposed to overlap vertically with the wafer W supported by the supporting pins 16.

An opening 13c is formed at the center of the bottom portion 13, and the fixing plates 77A and 77B and the movable cylinder 75 are installed to block the opening 13c from the outside of the process chamber 2. The movable cylinder 75 is a metallic cylindrical member having at a central portion thereof an opening 75a through which the shaft 14 can be inserted. The outer diameter of the movable cylinder 75 is slightly smaller than the inner diameter of the opening 13c in the bottom portion 13 so that the movable cylinder 75 can be inserted in the opening 13c. The inner diameter of the opening 75a of the movable cylinder 75 is sufficiently greater, e.g., about 4 to 5 times greater than the diameter of the shaft 14.

The movable cylinder 75 is connected to the displacement drive unit 73. The movable cylinder 75 can be vertically displaced by a predetermined stroke by driving the displacement drive unit 73. An electromagnetic wave shield member (not shown) for preventing leakage of microwaves is provided between the movable cylinder 75 and the fixing plates 77A and 77B, between the fixing plates 77A and 77B and the bottom portion 13, and between the fixing plates 77A and 77B and the shaft 14. A vacuum seal member for ensuring airtightness in the process chamber 2 may be provided between the movable cylinder 75 and the fixing plates 77A and 77B, between the fixing plates 77A and 77B and the bottom portion 13, and between the fixing plates 77A and 77B and the shaft 14, if necessary.

FIG. 16 shows a state in which the movable cylinder 75 is lowered. Specifically, the upper end of the movable cylinder 75 is positioned flush with the upper ends of the fixing plates 77A and 77B. Therefore, the upper end of the movable cylinder 75 is retracted to a position lower than the inner surface 13b of the bottom portion 13. As shown in FIG. 16, in a state where the movable cylinder 75 is lowered, the phase control unit 7B has a recessed portion with respect to the inner surface 13b of the bottom portion 13. The movable cylinder 75, the fixing plates 77A and 77B and the bottom portion 13 are made of a metal for reflecting the microwaves. In a state where the movable cylinder 75 is lowered to the position shown in FIG. 16, the phases of the standing waves in the process chamber 2 can be changed by the incidence and reflection of the microwaves in the recessed portion (the opening 13c) of the phase control unit 7B surrounded by the metallic walls. In other words, by the phase control unit 7B having the recessed portion formed by the movable cylinder 75, the position of the standing waves can be shifted compared to the case where the inner surface 13b of the bottom portion 13 is flat.

FIG. 17 shows a state in which the movable cylinder 75 is raised by an amount corresponding to the thickness of the bottom portion 13 from the position shown in FIG. 16. At the raised position shown in FIG. 17, the upper end of the movable cylinder 75 is positioned substantially flush with the inner surface 13b of the bottom portion 13. Further, the inner diameter of the opening 75a of the movable cylinder 75 is sufficiently greater than the outer diameter of the shaft 14. Therefore, a recessed portion is formed around the shaft 14 even in a state where the movable cylinder 75 is raised as shown in FIG. 17. By displacing the movable cylinder 75 to the position shown in FIG. 17, the inner diameter of the recessed portion of the phase control unit 7B is materially reduced compared to that in the state shown in FIG. 16.

Although it is not shown, the upper portion of the movable cylinder 75 may protrude into the space S2 in the process chamber 2 by further raising the movable cylinder 75 from the position shown in FIG. 17. In that case, the phase control unit 7B can have a protruded portion protruding into the space S2 due to the movable cylinder 75 and, also, the depth of the recessed portion can be increased.

In the microwave heating apparatus 1B of the present embodiment, the position of the movable cylinder 75 may be fixed or may be displaced continuously or discontinuously during the heating process. By vertically displacing the movable cylinder 75 continuously or discontinuously during the heating process, the inner diameter or the depth of the recessed portion or the height of the protruded portion of the phase control unit 7B can be changed. By changing the inner diameter or the depth of the recessed portion or the height of the protruded portion of the phase control unit 7B during the heating process, the phases of the standing waves in the process chamber 2 can be controlled and, further, the uniform heating over the surface of the wafer W can be realized.

[Modification]

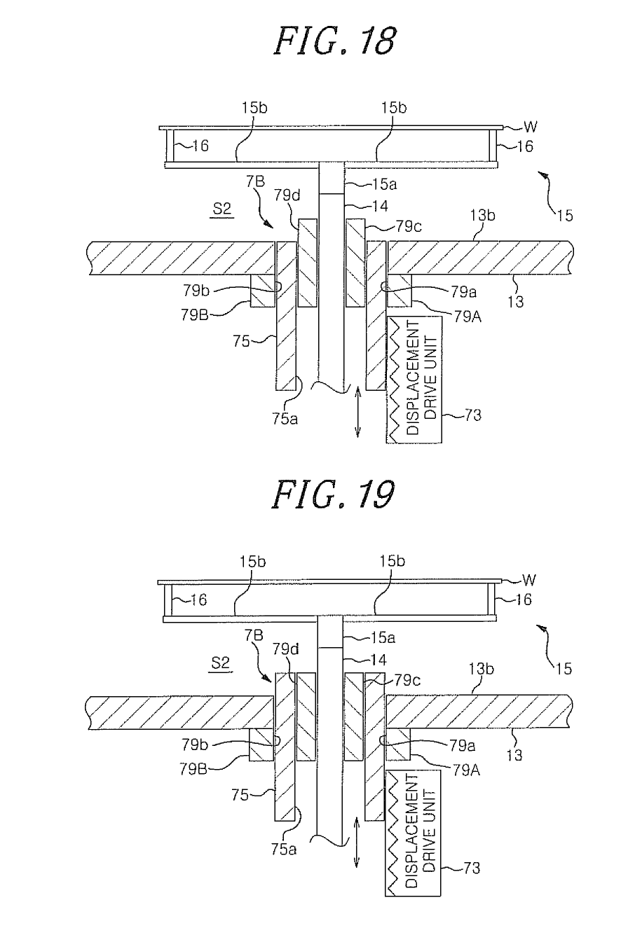

Hereinafter, a modification of the microwave heating apparatus in accordance with the third embodiment of the present invention will be described with reference to FIGS. 18 and 19. FIGS. 18 and 19 are partial enlarged cross sectional views showing configurations around a phase control unit in the microwave heating apparatus 1B of the present modification. The phase control unit 7B of the microwave heating apparatus 1B of the present modification includes: a movable cylinder 75 that is a movable member installed at the bottom portion 13 of the process chamber 2 to protrude into and retract from the space S2 in the process chamber 2; a displacement drive unit 73 for vertically displacing the movable cylinder 75; and fixing plates 79A and 79B attached to the lower surface of the bottom portion 13 from the outside of the process chamber 2. The fixing plate 79A is a metallic half-tubular member having an opening 79a through which the movable cylinder 75 can be inserted and a protrusion 79c. The fixing plate 79B is a metallic half-tubular member having an opening 79b through which the movable cylinder 75 can be inserted and a protrusion 79d. The fixing plates 79A and 79B are fixed to the bottom portion 13 by a fixing device (not shown) such as a screw or the like. The protrusions 79c and 79d protrude into the space S2 in the process chamber 2 and form a protruded portion of the phase control unit 7B.

FIG. 18 shows a state in which the upper end of the movable cylinder 75 is positioned flush with the inner surface 13b of the bottom portion 13. As shown in FIG. 18, in a state where the upper end of the movable cylinder 75 is positioned flush with the inner surface 13b of the bottom portion 13, the phase control unit 7B has the protrusions 79c and 79d of the fixing plates 79A and 79B. The phases of the standing waves in the process chamber 2 can be changed by the reflection of the microwaves from the protrusions 79c and 79d that are metallic walls. In other words, by the phase control unit 7B having the protrusions 79c and 79d, the position of the standing waves can be shifted compared to the case where the inner surface 13b of the bottom portion 13 is flat.

FIG. 19 shows a state in which the upper end of the movable cylinder 75 is raised to the heights of the protrusions 79c and 79d from the position shown in FIG. 18. The upper end of the movable cylinder 75 that has been raised as shown in FIG. 19 is positioned substantially flush with the upper ends of the protrusions 79c and 79d. Therefore, the diameter of the protruded portion of the phase control unit 7B is equal to the sum of the widths of the protrusions 79c and 79d and the thickness of the movable cylinder 75. By displacing the movable cylinder 75, the diameter of the protruded portion of the phase control unit 7B can be changed. Therefore, the phases of the standing waves in the process chamber 2 can be controlled by displacing the movable cylinder 75 in the phase control unit 7B during the heating process.

As described above, in the microwave heating apparatus 1B of the present embodiment, the phase control unit 7B for changing the phases of the standing waves is provided at the space S2 or at the position facing the space S2, so that the phases of the standing waves in the space S2 can be changed. Moreover, the phases of the standing waves in the process chamber 2 can be controlled by changing the inner diameter or the depth of the recessed portion or the height or the diameter of the protruded portion by displacing the movable cylinder 75 in the phase control unit 7B. Therefore, the uniform heating over the surface of the wafer W can be achieved.

The movable cylinder 75 may be formed in a polygonal tube shape, e.g., a triangular tube shape, a square tube shape or the like. Further, the movable cylinder 75 may be, e.g., divided into a plurality of parts that forms as a whole a cylindrical shape.

The other configurations and effects of the microwave heating apparatus 1B of the present embodiment are the same as those of the microwave heating apparatus 1 of the first embodiment, so that the redundant description thereof will be omitted.

### Fourth Embodiment

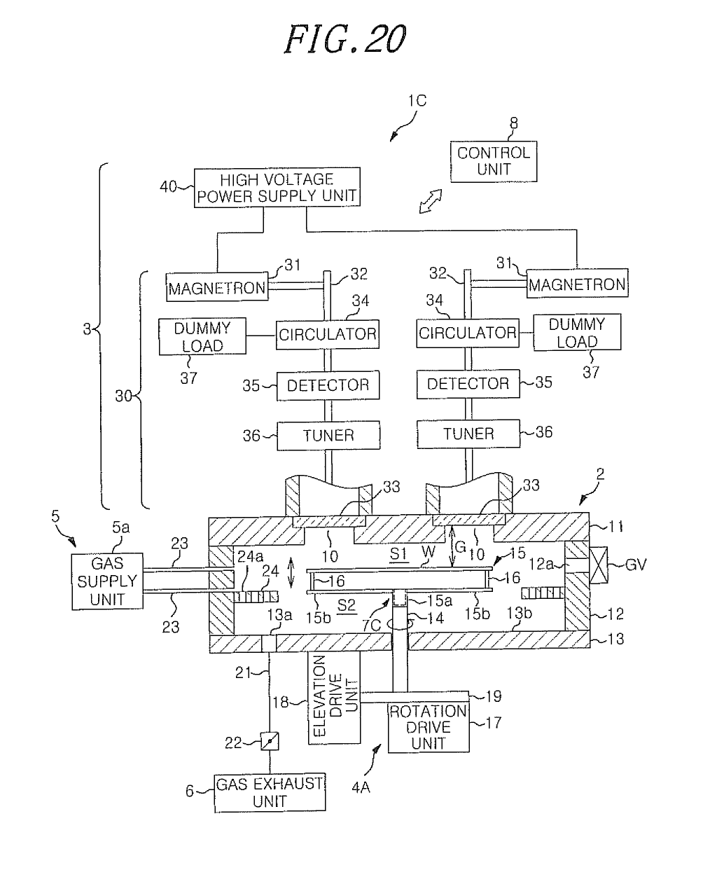

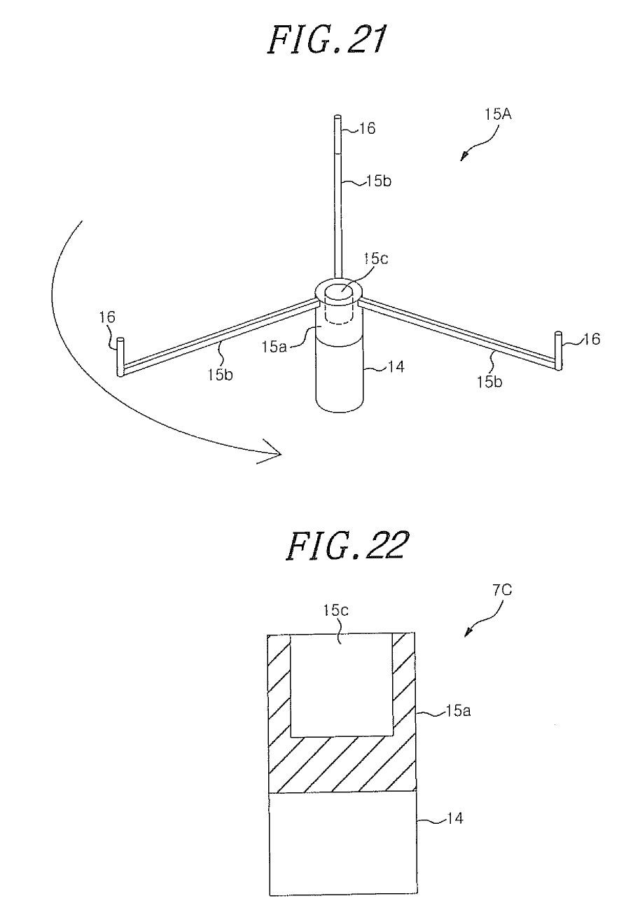

Hereinafter, a microwave heating apparatus in accordance with a fourth embodiment of the present invention will be described with reference to FIGS. 20 to 22. FIG. 20 is a cross sectional view showing a schematic configuration of a microwave heating apparatus 1C of the present embodiment. FIG. 21 is a perspective view showing an entire holder 15A. FIG. 22 is a cross sectional views showing a base portion 15a of the holder 15A. The microwave heating apparatus 1C of the present embodiment performs a heating process by irradiating microwaves to, e.g., a wafer W, through a plurality of consecutive operations. In the following description, differences between the microwave heating apparatus 1 of the first embodiment and the microwave heating apparatus 1C of the present embodiment will be described. In FIGS. 20 to 22, like reference numerals will be used for like parts as those of the microwave heating apparatus 1 of the first embodiment, and redundant description will be omitted.

The microwave heating apparatus 1C of the present embodiment includes: a process chamber 2 for accommodating therein a wafer W; a microwave introduction unit 3 for introducing microwaves into the process chamber 2; a supporting unit 4A for supporting the wafer W in the process chamber 2; a gas supply mechanism 5 for supplying a gas into the process chamber 2; a gas exhaust unit 6 for vacuum-exhausting the process chamber 2; a phase control unit 7C for changing the phases of standing waves of the microwaves introduced into the process chamber by the microwave introduction unit 3; and a control unit 8 for controlling the respective components of the microwave heating apparatus 1C.

<Phase Control Unit>

The phase control unit 7C of the microwave heating apparatus 1C of the present embodiment is provided at the supporting unit 4A. The phase control unit 7C has a recessed portion 15c formed at the base portion 15a of the holder 15A. The recessed portion 15c is a circular recess. The phase control unit 7C changes the phases of the standing waves of the microwaves introduced into the process chamber 2 by the microwave introduction unit 3. Specifically, the phase control unit 7C is disposed directly below the central portion of the wafer W supported by the supporting pins 16 and changes the phases of the standing waves of the microwaves below the wafer W.

The holder 15A is made of, e.g., a dielectric material such as quartz, ceramic or the like. The phases of the microwaves incident into the recessed portion 15c is changed by the reflection of the microwaves in the recessed portion 15c or refraction of the microwaves passing through the holder 15A. Accordingly, the uniform heating over the surface of the wafer W can be achieved by controlling the phases of the standing waves in the process chamber 2 by controlling the depth or the inner diameter of the recessed portion 15c.

In addition, the recessed portion 15c is not limited to a circular shape or may be formed in a polygonal shape, e.g., a triangular shape, a square shape or the like.

The other configurations and effects of the microwave heating apparatus 1C of the present embodiment are the same as those of the microwave heating apparatus 1 of the first embodiment, so that the redundant description thereof will be omitted.

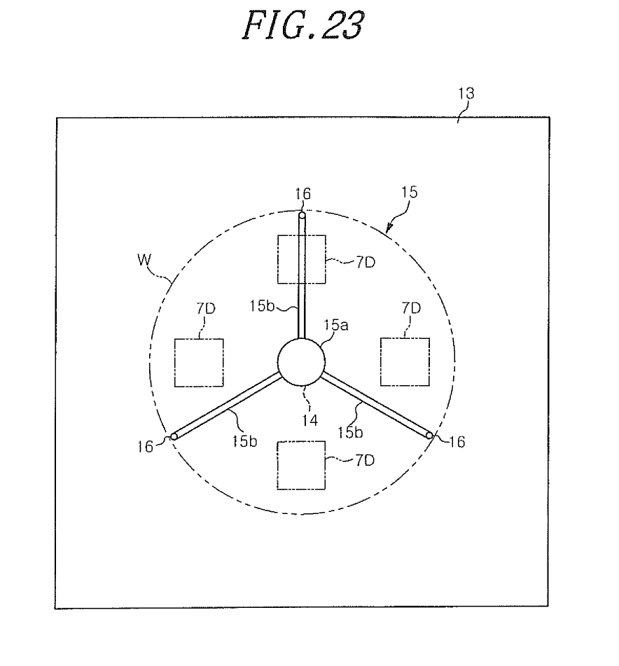

In the first to the third embodiment, one phase control unit 7, 7A or 7B is provided around the shaft 14. Alternatively, the phase control unit may be provided at a plurality of locations. FIG. 23 is a top view of the bottom portion 13 which is seen from the inside of the process chamber 2. FIG. 23 shows an exemplary arrangement in the case of providing the phase control unit at a plurality of locations. In FIG. 23, only the locations of the phase control unit 7D are illustrated. The configuration of the phase control unit 7D may be, e.g., the same as that of the phase control unit 7, 7A or 7B of the first to the third embodiment. FIG. 23 shows four phase control units 7D provided symmetrically with respect to the shaft 14 of the supporting unit 4. By providing the phase control units 7D at symmetrical locations with respect to the shaft 14 which is the rotation center of the wafer W, it is possible to improve the uniformity of the heating process in the diametrical direction of the wafer W.

The number of the phase control units 7D is not limited to four and may be any number greater than or equal to two.

Hereinafter, results of tests that have examined the effects of the present invention will be described.

### Test Example 1

A wafer W was subjected to a heating process by using a microwave heating apparatus having the same configuration as the microwave heating apparatus 1 shown in FIG. 1 except for the change in the arrangement of the four microwave introduction ports 10. In this test, the wafer W was heated for five minutes by introducing microwaves from the microwave introduction ports 10 at a power of 1250 W while introducing nitrogen gas at 40 L/min (slm) into the process chamber 2. In a comparative test, a wafer W was subjected to a heating process under the same conditions by using a microwave heating apparatus having the same configuration as the microwave heating apparatus 1 shown in FIG. 1 except that the bottom portion 13 is a flat surface.

After the heating process for five minutes, the temperature difference between the central portion and the edge portion of the wafer W was measured. As a result, in the case of using the microwave heating apparatus having the phase control unit 7 of the present invention, the temperature difference between the central portion and the edge portion of the wafer W was 14° C. On the other hand, in the case of using the microwave heating apparatus of the comparative example, the temperature difference between the central portion and the edge portion of the wafer W was 79° C. It is clear from the test results that in the case of using the microwave heating apparatus having the phase control unit 7 of the present invention, the temperature difference in the surface of the wafer W is reduced and thus the uniform heating can be obtained.

### Test Example 2

There was performed a simulation of a process of heating a silicon wafer doped with arsenic as impurities in the microwave heating apparatus 1C of the fourth embodiment (FIGS. 20 to 22). A depth of the recessed portion 15c was set to 25 mm. As for a comparison example, there was performed a simulation of a process of heating a wafer W under the same conditions by using a microwave heating apparatus having the same configuration as the microwave heating apparatus 1C shown in FIGS. 20 to 22 except that the phase control unit 7C (the recessed portion 15c) is not provided. In the simulation, a deviation of a sheet resistance in the surface of the wafer W was evaluated. As a result, the standard deviation of the sheet resistance in the surface of the silicon wafer was 1.0% in the simulation using the microwave heating apparatus 1C of the present invention. On the other hand, the standard deviation of the sheet resistance in the surface of the silicon wafer was 1.9% in the comparison example. The simulation results show that the uniform heating over the surface of the wafer W can be realized by using the microwave heating apparatus having the phase control unit 7C of the present invention.

The present invention may be variously modified without being limited to the above embodiments. For example, the microwave heating apparatus of the present invention is not limited to the case of using a semiconductor wafer as an object to be processed, and may be applied to the case of using, e.g., a substrate for a solar cell panel or a substrate for a flat panel display, as an object to be processed.

While the invention has been shown and described with respect to the preferred embodiments, it will be understood by those skilled in the art that various changes and modifications may be made without departing from the spirit and scope of the invention as defined in the following claims.

What is claimed is:

1. A microwave heating apparatus comprising:
a process chamber configured to accommodate an object to be processed, the process chamber having a top wall, a bottom wall and a sidewall;
a microwave introduction unit configured to generate a microwave for heating the object and introduce the microwave into the process chamber;
a supporting unit configured to make contact with the object to support the object in the process chamber; and
a phase control unit disposed below the object supported by the supporting unit and configured to change a phase of a standing wave of the microwave introduced into the process chamber by the microwave introduction unit.

2. The microwave heating apparatus of claim 1, wherein at least a part of the phase control unit vertically overlaps with the object supported by the supporting unit.

3. The microwave heating apparatus of claim 1, wherein the phase control unit includes a recessed portion or a protruded portion with respect to an inner surface of the bottom wall.

4. The microwave heating apparatus of claim 3, wherein the phase control unit further includes a movable member configured to adjust a depth of the recessed portion or a height of the protruded portion, and a drive unit configured to move the movable member.

5. The microwave heating apparatus of claim 3, wherein the phase control unit further includes a movable member configured to adjust an inner diameter of the recessed portion or a diameter of the protruded portion, and a drive unit configured to move the movable member.

6. The microwave heating apparatus of claim 3, wherein the phase control unit further includes an auxiliary member that adjusts a depth of the recessed portion or a height of the protruded portion.

7. The microwave heating apparatus of claim 3, wherein the phase control unit further includes an auxiliary member that adjusts an inner diameter of the recessed portion or a diameter of the protruded portion.

8. The microwave heating apparatus of claim 3, wherein the recessed portion is defined by metallic walls or the protruded portion is made of a metal.

9. The microwave heating apparatus of claim 1, wherein the phase control unit is provided at a plurality of locations.

10. The microwave heating apparatus of claim 1, wherein the supporting unit includes:
a base portion;
an arm extending radially from the base portion; and
a supporting member fixed to the arm and configured to make contact with the object to support the object,
wherein the phase control unit has a recessed portion formed at the base portion.

11. The microwave heating apparatus of claim 10, wherein the base portion is made of a dielectric material.

12. The microwave heating apparatus of claim 1, further comprising a rotation mechanism configured to horizontally rotate the object supported by the supporting unit.

13. The microwave heating apparatus of claim 1, wherein the supporting unit further includes a height position control mechanism configured to control a height position of the object supported by the supporting unit.

14. The microwave heating apparatus of claim 1, wherein the top wall of the process chamber has a plurality of microwave introduction ports through which the microwave generated by the microwave introduction unit is introduced into the process chamber.

15. A method for heating an object by the microwave heating apparatus of claim 1.
